(19) United States
(12) Patent Application Publication
(10) Pub. No.: US 2010/0039819 A1
(43) Pub. Date: Feb. 18, 2010

(54) FLOODLIGHT WITH TILTABLE BEAM

(75) Inventors: Denis Fournier, Lyon (FR); Matthias Jouffrieau, Lyon (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/521,158

(22) PCT Filed: Dec. 21, 2007
(86) PCT No.: PCT/IB2007/055290

§ 371 Date: Jun. 25, 2009

(30) Foreign Application Priority Data
Dec. 29, 2006 (EP) 06301303.1

(51) Int. Cl. F21S 8/00; F21V 5/00

(52) U.S. Cl. 362/268; 362/331

(57) ABSTRACT

A floodlight comprises means (110) for generating a parallel beam having a general direction (AA), a first convergent lenses array (120) for generating a plurality of convergent beams from said parallel beam, and a second lenses array (130) parallel to and integral with said first lenses array. The floodlight further comprises means for rotating simultaneously said first and second lenses arrays about an axis perpendicular to the general direction of the parallel beam.

### FIELD OF THE INVENTION

The invention relates to a floodlight intended to be used in various illumination applications. This invention is particularly relevant for stage, faæade or accent lighting.

### BACKGROUND OF THE INVENTION

In the lighting field, various kinds of light beams are often required. On the one hand, when a faæade is to be illuminated, a wide light beam may be desired, so as to illuminate the whole faæade. On the other hand, a narrow light beam may be needed to illuminate only a detail of a faæade. To this end, various floodlights are used.

Moreover, floodlights are often inserted into recessed cavities, for instance in a pavement, in a sidewalk or in a wall. Therefore, it is necessary that the light beam be properly oriented towards the element to be illuminated.

International patent publication WO 2005/093319 discloses a floodlight wherein a light beam provided by a light-emitting diode (LED) may be tilted. This floodlight comprises a first array of lenses provided on the path of the beam which may be moved by translation with respect to a second array of lenses provided parallel to the first array.

This translation movement requires complicated mechanical means for positioning properly one array with respect to the other and permitting one array to move with respect to the other. Furthermore, correctly orienting the light beam is a complex operation because of the complexity of the mechanical means for positioning the arrays.

### SUMMARY OF THE INVENTION

It is an object of embodiments of the invention to provide a floodlight which can provide various light beam orientations easily and without the need of a complex mechanical positioning system.

To this end, embodiments of the invention propose a floodlight comprising means for generating a parallel beam having a general direction, a first convergent lenses array for generating a plurality of convergent beams from said parallel beam, and a second lenses array parallel to and integral with said first lenses array. The floodlight further comprises means for rotating simultaneously said first and second lenses arrays about an axis perpendicular to the general direction of the parallel beam.

When the lenses arrays are rotated, the light beam which emerges from the floodlight is tilted with respect to the general direction of the parallel light beam. In other words, the emerging light beam has a general direction (the “emerging general direction”) which forms an angle with that of the generated parallel light beam. Moreover, this system permits to change the beam width.

In an embodiment of the invention, the second lenses array is located on the plane where the rays of the convergent beams converge (the “convergence plane”). In this embodiment, it is possible to broaden the light beam as well as tilt it, simply by rotating the optical system formed by said first and second lenses arrays.

In another embodiment of the invention, the convergent lenses array comprises a central zone and a surrounding zone around the central zone. The lenses of the central zone have a greater focal distance than the focal distance of the lenses of the surrounding zone. The central and surrounding zones are arranged such that the convergent lenses array has a single convergence plane. This arrangement is particularly useful when it is desired to tilt a wide light beam. Because the central zone has a greater focal distance, it permits redirecting a greater proportion of the luminous flux received at the central zone in the general direction of the tilted light beam. Otherwise, the borders of the element which is to be illuminated would be too brightly illuminated as compared to the center of said element.

In a further embodiment of the invention, the floodlight comprises a third convergent lenses array for generating a collimated beam from the beams at the exit of the second lenses array. Said third convergent lenses array is parallel to and integral with said first and second lenses arrays. This arrangement is particularly useful in order to obtain an afocal optical system. An afocal optical system finds its utility when it is desired to tilt a narrow light beam, without broadening said light beam or with a reduced broadening of said light beam.

In an embodiment of the invention, the floodlight comprises a frame which is positioned around said means for generating a parallel beam. This frame is tiltable and constitutes a support for the lenses arrays.

Preferably, the means for generating a parallel beam comprise a light source and collimating means.

Embodiments of the invention also relate to a lens assembly adapted to be used in such a floodlight.

These and other aspects of embodiments of the invention will be apparent from and will be elucidated with reference to the embodiments described hereinafter.

### BRIEF DESCRIPTION OF THE DRAWINGS

Embodiment of the invention will now be described in more details by way of example with reference to the accompanying drawings, in which:

FIG. 1 shows a floodlight in accordance with a first embodiment of the invention, in two different positions;

FIG. 2 shows a floodlight in accordance with a second embodiment of the invention, in two different positions;

FIG. 3 shows a cross-sectional view of a lenses array according to the second embodiment of the invention.

### DETAILED DESCRIPTION OF THE INVENTION

In the instant specification, the beam width is measured according to the full-width half-maximum method (FWHM), which is well known in the art.

Lenses arrays consist of a plurality of lenses the optic axis of which are parallel two by two. A focal plane of a lenses array is a plane which is perpendicular to the optic axis of the lenses of said array and passes through the focal point of at least one lens of the lenses array. When two lenses arrays are described as parallel, it means that a focal plane of a first lenses array is parallel to a focal plane of a second lenses array.

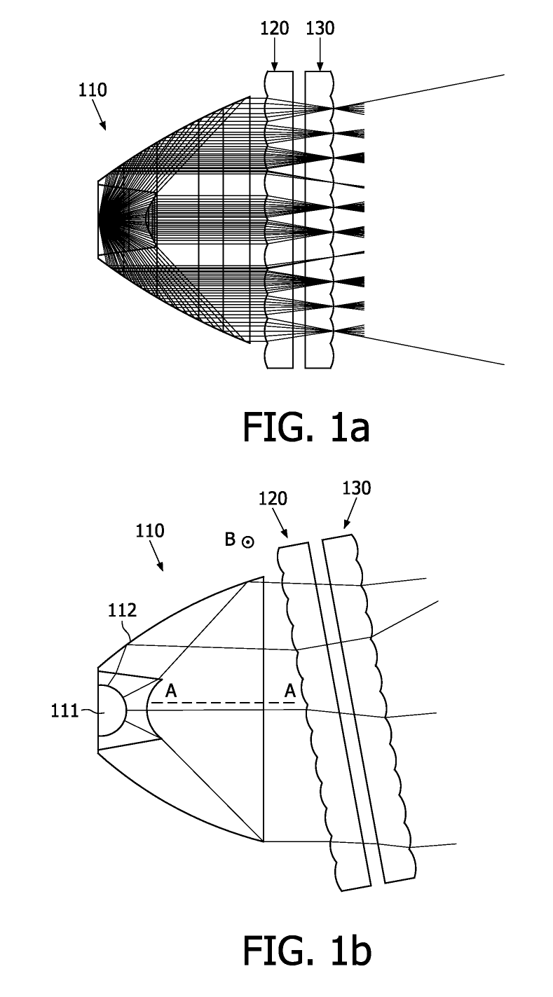

A floodlight in accordance with a first embodiment of the invention is depicted in FIGS. 1a and 1b. This floodlight comprises means 110 for generating a parallel beam. The parallel beam has a general direction AA. A first lenses array 120 is located on the path of the parallel beam. First lenses array 120 comprises a plurality of convergent lenses, for generating a plurality of convergent beams from said parallel beam. The convergent beams converge towards a convergence plane. The floodlight further comprises a second lenses array 130 parallel to the first lenses array 120. The second lenses array 130 is on the path of the converging light beams. In this example, said second lenses array comprises a plurality of plano-concave lenses, i.e. divergent lenses. However, a convergent lenses array could also be used.

First and second lenses arrays are integral with each other. The two lenses arrays 120, 130 may be fixed together with simple mechanical means. For instance, the lenses arrays may be positioned with rods and glue, to fix together the arrays and the rods. The lenses arrays may also be part of a same system obtained, for instance, with a single mould. Thus, there is no need of a complex positioning system of the lenses with respect to one another. First and second lenses arrays are positioned with a predetermined spacing therebetween. For instance, the predetermined spacing between the first and second lenses arrays is chosen so that said second lenses array is located on the convergence plane of the first lenses array.

The floodlight further comprises means for rotating simultaneously said lenses arrays about an axis BB perpendicular to the general direction AA of the parallel beam. These rotation means are not shown on the figures. For instance, the arrays may be positioned on a frame which is movable with respect to a frame support, and the latter is equipped with means for rotating the frame about axis BB. The means for rotating the frame may be a bolt and nut arrangement which works in cooperation with the frame support to rotate the frame. The frame itself constitutes a support for the arrays. Such an arrangement makes it quite easy to give any desired orientation to the light beam, simply by screwing the bolt and nut arrangement until the adequate tilting is reached.

It may also be useful to envisage means for rotating simultaneously said lenses arrays about a further axis CC which is perpendicular to axis BB and axis AA. This permits a beam tilting in every directions.

On FIG. 1a, the lenses arrays have not been rotated. Therefore, the light beam is not tilted. On FIG. 1b, the lenses arrays have been rotated. As can be seen, the light beam is tilted: its general direction forms an angle with the general direction AA of the initial parallel beam.

Different kinds of lenses may be used, depending on the geometry of the element which it is desired to illuminate. An array of cylindric lenses can be used in order to obtain linear beams. Linear beams are useful to illuminate bridges for instance. Spherical or aspherical lenses may also be used. Spherical and aspherical lenses are useful to obtain a round beam. Such beams may be used to illuminate a faæade or a detail of a faæade. Aspherical lenses are useful to eliminate spherical aberations.

The means 110 for generating a parallel beam are well-known in the art. For instance, they comprise a light source 111. The light source 111 in FIGS. 1a and 1b, as well as in the other Figures, is a LED, but any other light source may be used. In this embodiment the light source 111 is used in combination with a parabolic reflector 112 as collimating means. For example, LEDs of the type commercialized by Philips under reference Luxeon® K2 (white, green, blue, red or amber) is adapted as a light source. Such collimating means 112 are also well-known to those skilled in the art. For example, a collimator of the type commercialized by Fraen under reference FHS-HMB1 is adapted for generating a parallel beam.

In this embodiment, the light beam generally has a medium width, for instance lower than 2×15°, although this embodiment is not limited to this example.

In the case when it is desired to tilt a wide light beam, for instance having a width greater than 2×15° and maybe up to 2×20°, it may be necessary to redirect a greater proportion of the luminous flux towards the element to be illuminated. Otherwise, part of the element would be illuminated more brightly than the rest of this element.

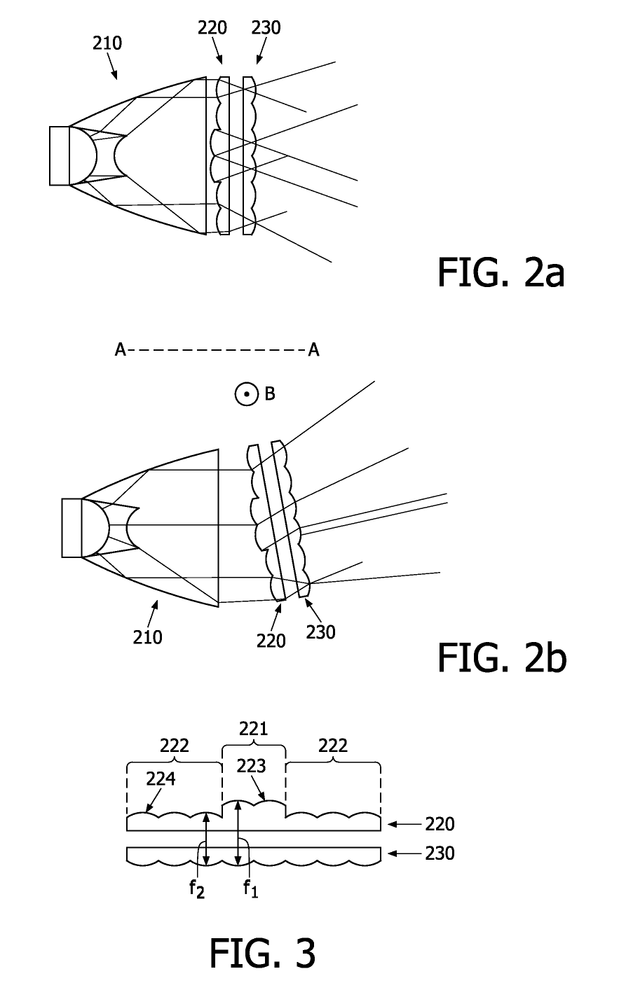

To this end, FIGS. 2 and 3 depict an embodiment of the invention, wherein the convergent lenses array 220 comprises a central zone 221 and a surrounding zone 222 around the central zone 221. The lenses 223 of the central zone 221 have a greater focal distance f1 than the focal distance f2 of the lenses 224 of the surrounding zone 222. In other words, the optical power of the lenses 223 of the central zone 221 is lower than the optical power of the lenses 224 of the surrounding zone 222. Thus, the light rays which are intercepted by the lenses 223 of the central zone 221 undergo a lower change of direction than the light rays which are intercepted by the lenses 224 of the surrounding zone 222. This results in an improved distribution of the light flux.

The central zone 221 and surrounding zone 222 are arranged such that the convergent lenses array 220 has a single convergence plane. In the embodiment of FIG. 2, the second lenses array is located on the convergence plane of the first lenses array. The second lenses array 230 is on the path of the converging light beams. In this example, said second lenses array comprises a plurality of plano-convex lenses, i.e. convergent lenses. However, a divergent lenses array could also be used.

On FIG. 2a, the lenses arrays have not been rotated. Therefore, the light beam is not tilted. On FIG. 2b, the lenses arrays have been rotated. As can be seen, the light beam is tilted: its general direction forms an angle with the general direction AA of the initial parallel beam.

The means for rotating the lenses arrays are not illustrated on FIG. 2. The same as those described in relation with the first embodiment may be used in the second embodiment of the invention.

The use of an afocal optical system permits to tilt the light beam without widening it. This is quite useful when it is desired to illuminate a detail of faæade for instance. In this case, the light beam is generally narrow, for instance lower than 2×7°, although this embodiment is not limited to this example.

To obtain an afocal system, a third convergent lenses array is provided for generating a collimated beam from the beams at the exit of the second lenses array. Said third convergent lenses array is parallel to and integral with said first convergent lenses array and second lenses array. Each lens of the third lenses array has a source focal point F_{S} which corresponds to the image focal point F₁ of a lens of the second lenses array.

The second lenses array is located on the convergence plane of the first lenses array. The second lenses array is on the path of the converging light beams. In this example, said second lenses array comprises a plurality of plano-convex lenses, i.e. convergent lenses. The third lenses array is on the path of the converging light beams. In this example, said third lenses array also comprises a plurality of plano-convex lenses. Because the source focal point of the convergent lenses of the third lenses array is confounded with the image focal point of the convergent lenses of the second lenses array, the light beams which emerge from the third lenses array are collimated.

The same means for rotating the lenses arrays as those described in relation with the first embodiment may be used in this embodiment of the invention.

Any reference sign in the following claims should not be construed as limiting the claim. It will be obvious that the use of the verb “to comprise” and its conjugations does not exclude the presence of any other element besides those defined in any claim. The word “a” or “an” preceding an element does not exclude the presence of a plurality of such elements.

1. A floodlight comprising means (110) for generating a parallel beam having a general direction (AA), a first convergent lenses array (120) for generating a plurality of convergent beams from said parallel beam, and a second lenses array (130) parallel to and integral with said first lenses array, the floodlight further comprising means for rotating simultaneously said first and second lenses arrays about an axis perpendicular to the general direction of the parallel beam.

2. The floodlight as claimed in claim 1, wherein said second lenses array is located on the plane where the rays of the convergent beams converge.

3. The floodlight as claimed in claim 2, wherein said convergent lenses array comprises a central zone and a surrounding zone around the central zone, the lenses of the central zone having a greater focal distance than the focal distance of the lenses of the surrounding zone, said central and surrounding zones being arranged such that the convergent lenses array has a single convergence plane.

4. The floodlight as claimed in claim 2, wherein it further comprises a third convergent lenses array for generating a collimated beam from the beams at the exit of the second lenses array, said third convergent lenses array being parallel to and integral with said first and second lenses arrays.

5. The floodlight as claimed in claim 1, said floodlight comprising a frame which is positioned around said means for generating a parallel beam, said frame being tiltable and constituting a support for said lenses arrays.

6. The floodlight as claimed in claim 1, wherein said means for generating a parallel beam comprise a light source and collimating means.

7. A lens assembly comprising a first convergent lenses array (120) for generating a plurality of convergent beams from a parallel beam, and a second lenses array (130) parallel to and integral with said first lenses array.
